(19) United States
(12) Patent Application Publication
(10) Pub. No.: US 2020/0347978 A1
(43) Pub. Date: Nov. 5, 2020

(54) THERMAL EXPANSION/PRESSURE COMPENSATOR

(71) Applicant: GE Global Sourcing LLC, Norwalk, CT (US)

(72) Inventors: Kevin Paul Bailey, Mercer, PA (US); Nick Alan Estock, Mason, OH (US); Prabhakaran Selvaraj, Bangalore (IN); Charles Bernard Atz, New Castle, PA (US); Pratik Rajendra Nirhali, Bangalore (IN); Pushkar Haresh Sheth, Bangalore (IN)

(21) Appl. No.: 16/398,517

(22) Filed: Apr. 30, 2019

(51) Int. Cl. F16L 51/03; F16L 51/02

(52) U.S. Cl. CPC F16L 51/035; B33Y 80/00; F16L 51/028; F16L 51/025

(57) ABSTRACT

A thermal expansion/pressure compensator includes a body having an inlet at a first connection point and an outlet at a second connection point. The body includes a flexible member extending along a portion of the body. The body has an internal chamber configured to receive a fluid via the inlet. The internal chamber is shaped to direct fluid through the flexible member and out of the body via the outlet. The flexible member is configured to flex responsive to expansion of the body. The compensator also includes a rigid member operably coupled with the body. The rigid member is thermally and fluidly isolated from the body and the flexible member. The body, the flexible member, and the rigid member are formed as a unitary structure.

### FIELD

Embodiments of the present disclosure generally relate to thermal compensators within piping systems.

### BACKGROUND

Piping systems frequently carry fluids that vary significantly in operational temperatures and internal pressures during normal operation. These pipe assemblies typically include components that accommodate the expansion/pressure of the structure due to the temperature differential, separate components to support the loads due to the internal pressure. These parts are normally manufactured of different materials and manufacturing methods, require significant time to assembly, and are prone to failure modes associated with the number of different components and methods used to join them together.

The joining of components included within such piping assemblies result in multiple connections and/or joints that inherently carry with them a high number of potential failure modes leading to poor reliability of the assembly. Additionally, the different manufacturing methods used to make each individual component increases the weight and cost of the assembly due to longer manufacturing times, material volumes, assembly time, inventory holding, and shipping costs.

### BRIEF DESCRIPTION

In one or more embodiments, a thermal expansion/pressure compensator includes a body having an inlet at a first connection point and an outlet at a second connection point. The body includes a flexible member extending along a portion of the body. The body has an internal chamber configured to receive a fluid via the inlet. The internal chamber is shaped to direct fluid through the flexible member and out of the body via the outlet. The flexible member is configured to flex responsive to expansion of the body. The compensator also includes a rigid member operably coupled with the body. The rigid member is thermally and fluidly isolated from the body and the flexible member. The body, the flexible member, and the rigid member are formed as a unitary structure.

In one or more embodiments, a thermal expansion/pressure compensator includes a body having an inlet at a first connection point and an outlet at a second connection point. The body includes one or more hermetic walls extending around and enclosing an internal chamber. The internal chamber receives a fluid via the inlet. The internal chamber is shaped to direct fluid through the body and the out of the body via the outlet. The compensator also includes a flexible member coupled with the body and extending along a portion of the body. The flexible member has a wall thickness that is thinner than a wall thickness of the body. The flexible member is configured to flex responsive to expansion of the body as a result of fluid moving within the internal chamber of the body. The compensator also includes a rigid member operably coupled with the body. The rigid member is thermally and fluidly isolated from the body and the flexible member. The rigid member is configured to remain stationary responsive to the fluid moving through the body. The body, the flexible member, and the rigid member are formed as a unitary structure.

In one or more embodiments, a thermal expansion/pressure compensator includes a body having an inlet at a first connection point and an outlet at a second connection point. The body includes one or more hermetic walls extending around and enclosing an internal chamber. The internal chamber is configured to receive a fluid via the inlet and is shaped to direct the fluid through the body and out of the body via the outlet. A flexible member is coupled with the body and extends along a portion of the body. The flexible member includes one or more protrusions extending away from an exterior surface of the body. Each of the one or more protrusions radially extends around a center axis of the body. Each protrusion has a wall thickness that is thinner than a wall thickness of the body. The flexible member is configured to flex responsive to expansion of the body. A rigid member is operably coupled with the body and includes a rigid body extending along a center axis of the body at a radial position away from the body. The rigid member is thermally and fluidly isolated from the body and the flexible member. The rigid member is configured to remain stationary responsive to the fluid moving through the body. The body, the flexible member, and the rigid member are additively manufactured as a unitary structure.

### BRIEF DESCRIPTION OF THE DRAWINGS

The subject matter described herein will be better understood from reading the following description of non-limiting embodiments, with reference to the attached drawings, wherein below:

FIG. 1 illustrates one pipe assembly with conventional expansion/pressure compensation assembly components;

FIG. 2 illustrates a perspective view of a thermal expansion/pressure compensator in accordance with one embodiment;

FIG. 3 illustrates a cross-sectional view of the thermal expansion/pressure compensator shown in FIG. 2;

FIG. 4 illustrates a perspective view of a thermal expansion/pressure compensator in accordance with one embodiment;

FIG. 5 illustrates a magnified cross-sectional partial view of the thermal expansion/pressure compensator shown in FIG. 4 in accordance with one embodiment;

FIG. 6 illustrates a perspective view of a thermal expansion/pressure compensator in accordance with one embodiment;

FIG. 7 illustrates a magnified cross-sectional partial view of the thermal expansion/pressure compensator shown in FIG. 6 in accordance with one embodiment;

FIG. 8 illustrates a perspective view of a thermal expansion/pressure compensator in accordance with one embodiment;

FIG. 9 illustrates a magnified cross-sectional partial view of the thermal expansion/pressure compensator shown in FIG. 8 in accordance with one embodiment;

FIG. 10 illustrates a perspective view of a thermal expansion/pressure compensator in accordance with one embodiment;

FIG. 11 illustrates a magnified cross-sectional partial view of the thermal expansion/pressure compensator shown in FIG. 10 in accordance with one embodiment;

FIG. 12 illustrates a cross-sectional view of the thermal expansion/pressure compensator shown in FIG. 10 in accordance with one embodiment; and

FIG. 13 illustrates a perspective view of a thermal expansion/pressure compensator in accordance with one embodiment.

### DETAILED DESCRIPTION

One or more embodiments of the inventive subject matter described herein relates to thermal expansion/pressure compensators that may be used in a fluid piping system. The thermal expansion/pressure compensators are at least partially additively manufactured in one embodiment such that the thermal expansion/pressure compensators are formed as a unitary or single piece component including a body, a flexible member, and a rigid member.

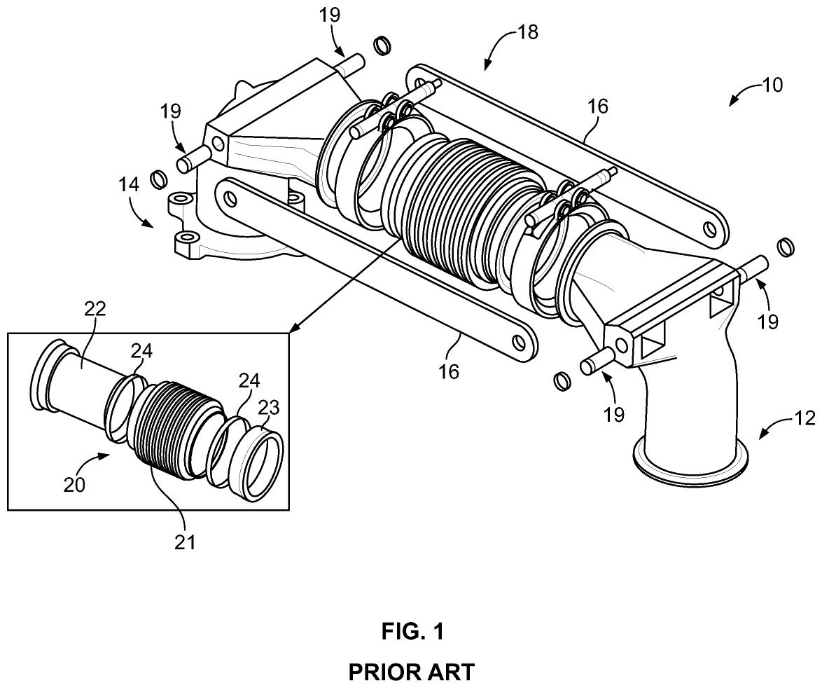

FIG. 1 illustrates an exploded view of one example of a piping system 10 subject to varying internal temperatures and pressures, requiring compensation of thermal expansion and support for internal pressure. The system 10 includes connection points 14, 12 that may be coupled with additional conduits of a piping system. An expansion compensator system 20 is disposed between the connection points 12, 14 and includes components, such as a bellow 21, integrated liner 22, flange 23, and weld rings 24. This assembly makes up an accordion like structure that accommodates the expansion of the structure in plural different directions due to the temperature differential. Support bars 16 are coupled with each connection point 12, 14 through pin joints 19 to accommodate the loads due to the internal pressure. The components (e.g., the expansion compensator system 20 and the support bars 16) accommodate the temperature differential and internal pressure to avoid significant load from being imparted on connection points 12, 14 at each end of the system 10.

One problem with the piping system 10 is that assembling or combining the multiple components includes numerous steps of fusing, combining, joining, or the like, each of the multiple components with each other. Each joint or coupling location may lead to potential failures of the entire piping system 10. The multiple components are made of different materials having different material properties that may respond to or react differently from each other component when the system 10 is subject to varying environments.

Fluid having a temperature differential relative to the compensator moves through the body and through the flexible member. The fluid varies in operational temperatures and exposes the thermal expansion/pressure compensator to internal pressures. The flexible member flexes or moves responsive to the temperature differential between the fluid moving through the body and connection points to accommodate the expansion of the structure. The flexible member alone, however cannot withstand the separating loads created by internal pressures of movement of the fluid inside the body. The flexible member is supported or at least partially supported by a rigid member such that the rigid member is thermally and fluidly isolated from the body and the flexible member. For example, the rigid member does not come into direct contact with the fluid having the varying temperature differential.

The rigid member remains substantially stationary responsive to the fluid moving through the body in order to accommodate and support the loads imparted due to internal pressure. For example, the rigid member does not move at all, or moves a minimal amount while the flexible member moves, the rigid member moves less than the flexible member at the same time as the flexible member moves, the rigid member moves less than the flexible member when exposed to the same internal fluid pressure and temperature, or the like. The single, unitary structure accommodates the multiple functions of the pipe assembly. The rigid member is not subject to the thermal variations due to isolation from direct contact with the fluid inside the compensator. The flexible member accommodates thermal expansion of the solid body between inlet and outlet connection points but does not need to carry the pressure loads along the length of the pipe, only radially.

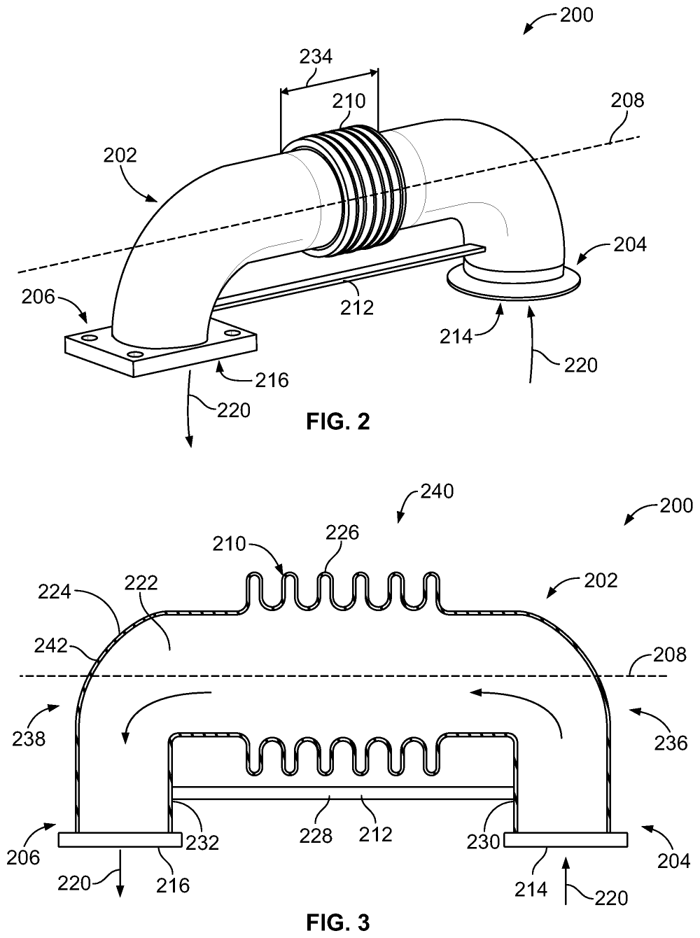

FIG. 2 illustrates a perspective view of a thermal expansion/pressure compensator 200 in accordance with one embodiment. FIG. 3 illustrates a cross-sectional view of the thermal expansion/pressure compensator 200. The thermal expansion/pressure compensator 200 may be coupled with pipes or conduits of a piping system (not shown) that may be used in any industrial or mechanical system where high temperature fluids are carried across distances or around corners. The thermal expansion/pressure compensator 200 includes a body 202 having an inlet 214 at a first connection point 204 and an outlet 216 at a second connection point 206. In alternative embodiments, the body 202 may include two or more inlets that direct the fluid into an internal chamber 222 and/or two or more outlets that direct the fluid out of the internal chamber 222. The compensator 200 is a piece of piping or conduit that may be coupled with pipes, conduits, or the like, at the first and second connection points 204, 206 (not shown). In the illustrated embodiment, the thermal expansion/pressure compensator 200 is included in a u-shaped pipe system, such that the compensator 200 includes inlet and outlet portions 236, 238 that extend in directions that are substantially perpendicular to a longitudinal portion 240. For example, the longitudinal portion 240 is elongated along a center axis 208 of the body 202, and the inlet and outlet portions 236, 238 are elongated along different axes that are substantially perpendicular to the center axis 208. In alternative embodiments, the body 202 may have an L-shape or may include no bends, or the body 202 may have any alternative shape.

The body 202 includes hermetic walls 242 that extend around and enclose the internal chamber 222 that receives a fluid 220 via the inlet 214. For example, the hermetic walls 242 completely seal or enclose the internal chamber 222 such that fluid may not penetrate, move through, or the like, the hermetic walls 242. The fluid may be a liquid phase of the fluid, a gas phase of the fluid, or a liquid-gas phase mixture of the fluid that moves or flows within the body 202. The fluid 220 enters the thermal expansion/pressure compensator 200 via the inlet 214, moves through the internal chamber 222, and flows out of the body 202 via the outlet 216. Optionally, the body 202 may include plural internal walls that may define and enclose plural internal chambers inside the body 202 that may be fluidly coupled with one or more other internal chambers, fluidly coupled with the inlet 214, with the outlet 216, or any combination therein.

The body 202 also includes a flexible member 210 that extends along a portion 234 of the body 202. The portion 234 of the body 202 is disposed and extends along the longitudinal portion 240 of body 202. In alternative embodiments, the flexible member 210 may extend a length along the portion 234 that is shorter or longer than the length illustrated, may be disposed closer to or further away from the inlet portion 236 relative to the outlet portion 238, may extend along the inlet portion 236 and/or the outlet portion 238 of the body 202, or any combination therein. In one or more embodiments, the thermal expansion/pressure compensator 200 may include two (or more) separate and distinct flexible members 210 (not shown) that are disposed at different positions of the body 202. For example, a first flexible member may extend along the longitudinal portion 240 of the body 202 and be disposed proximate the inlet portion 236, and a second flexible member may extend along the longitudinal portion 240 and may be disposed proximate the outlet portion 238. Optionally, the two or more separate and distinct flexible members may be disposed at any alternative position of the body 202.

The flexible member 210 can include plural protrusions 226 that extend away from an exterior surface 224 of the body 202. Alternatively, the flexible member 210 may include no protrusions, or may include a single protrusion. In the illustrated embodiment of FIG. 3, the flexible member 210 includes six protrusions 226, and each of the six protrusions 226 have substantially the same shape and size relative to at least one other protrusion 226. Alternatively, one or more of the protrusions may have a size and/or a shape that is different than a size and/or shape of one or more other protrusions. The protrusions 226 may extend substantially equal distances away from the exterior surface 224 of the body 202 or at least one protrusion may extend a distance away from the exterior surface 224 that is different than a distance at least one other protrusion extends. Optionally, the flexible member 210 may include no protrusions or any number of protrusions 226, and any number of the protrusions may have any unique and/or common shape relative to each other protrusion.

The protrusions 226 radially extend about the center axis 208 of the body 202. For example, a cross-sectional area of the flexible member 210 is greater or larger than a cross-sectional area of the body 202. In the illustrated embodiment, each protrusion 226 extends a substantially equal distance away from the center axis 208 as each other protrusion 226 such that a cross-sectional area of one protrusion 226 is substantially the same as a cross-sectional area of each other protrusion 226. In alternative embodiments, one or more of the protrusions 226 may be differently sized relative to each other protrusion 226 such that each protrusion 226 may have differently sized cross-sectional areas relative to each other protrusion 226. Additionally, each protrusion has a substantially circular cross-sectional shape, such that the protrusions extend substantially concentric about the center axis 208. In alternative embodiments, one or more, or all, of the protrusions may have another cross-sectional shape, such as a rectangular, diamond, or any quadrilateral shape.

The flexible member 210 can be an accordion-like or a wave-like structure that extends along the portion 234 of the body 202. For example, the flexible member 210 may be referred to as a bellow having plural convolutions that are shaped and sized to flex or be flexible in an axial direction (e.g., along the center axis 208) or in any alternative direction. In alternative embodiments, the flexible member 210 may have any alternative shape and/or size that allows the flexible member 210 to flex or move responsive to the fluid 220 moving within the body 202. For example, the flexible member 210 may be a flat or substantially flat surface that has a wall thickness that is thinner or less than a wall thickness of the body 202, the flexible member 210 may include one or more protrusions having any shape and/or size that may extend into the body 202 and/or away from the body 202, or the like.

The fluid 220 is received into the body 202 via the inlet 214, flows or moves through the flexible member 210, and out of the body 202 via the outlet 216. Responsive to the fluid 220 moving within the body 202, the flexible member 210 flexes, moves, expands, contracts, or the like, to accommodate thermal expansion of the body 202 as a result of a temperature differential of the fluid 220 within the thermal expansion/pressure compensator 200. The flexible member 210 flexes in plural different directions relative to the center axis 208 of the body 202 responsive to the fluid 220 moving within the body 202. For example, the flexible member 210 may flex or expand such that the protrusions 226 move further apart from each other protrusion 226 and/or closer toward each other protrusion 226, such that the protrusions 226 may further away from the center axis 208 of the body 202, such that the protrusions 226 move in any angular direction relative to the center axis 208, or the like.

In the illustrated embodiment of FIG. 3, the hermetic walls 242 of the body 202 have a wall thickness that is thicker than a wall thickness of each of the protrusions 226 of the flexible member 210. For example, in one embodiment, the protrusions may have a wall thickness that is about 1 millimeter (mm), and the walls of the body 202 may have a wall thickness that is about 4 mm. In alternative embodiments, the protrusions may have a wall thickness of about 3 mm, about 5 mm, about 10 mm, or greater than 10 mm, and the walls of the body 202 may have a wall thickness that is substantially the same or greater (e.g., thicker) than the wall thickness of the protrusions. Alternatively, the hermetic walls 242 may have a wall thickness that is thinner or less than a wall thickness of one or more, or all, of the protrusions. In one embodiment, the thinner walls of the flexible member 210 can allow the flexible member 210 to flex or move responsive to the expansion of the thicker hermetic walls from a temperature differential of the fluid 220 flowing or moving through the thermal expansion/pressure compensator 200. In one or more embodiments, the walls 242 of the body 202 and the walls of the flexible member 210 may be substantially the same.

The thermal expansion/pressure compensator 200 also includes a rigid member 212 coupled with the body 202. The rigid member 212 extends in a direction substantially parallel to the center axis 208 and is disposed at a radial position away from the body 202. In the illustrated embodiment, the rigid member 212 is shown as a single bar or a rod extending between the inlet and outlet portions 236, 238 of the body 202, however the rigid member 212 may have any alternative shape, size, configuration, orientation, or the like. For example, the rigid member 212 may be one or more extension rods, plates, a combination of two or more rods and/or plates, or the like, that is coupled with the body 202 at two different positions of the body 202 and remains substantially stable and/or rigid responsive to the fluid 220 moving within the body 202.

In the illustrated embodiment, the rigid member 212 includes a rigid body 228 having a first end 230 and a second end 232. The first end 230 of the rigid body 228 is coupled with the body 202 along the inlet portion 236 and the second end 232 of the rigid body 228 is coupled with the body 202 along the outlet portion 238. In the illustrated embodiment, the rigid member 212 extends in a direction between the first and second ends 230, 232 that is substantially parallel to the center axis 208. Optionally, the rigid member 212 may extend in any angular direction relative to the center axis 208.

The rigid member 212 may be a solid structure or component, may be a hollow structure, a portion of the member 212 may be hollow and another portion of the rigid member 212 may be solid, the rigid member 212 may include one or more internal passages, internal and/or external holes or openings, or the like. For example, the rigid member 212 may have any shape, size, and/or configuration. In alternative embodiments, the thermal expansion/pressure compensator 200 may include two or more rigid members that may be separate and distinct from each other or may be coupled with one or more rigid members. The plural rigid members may extend in any direction relative to each other, may be coupled with any body 202 at any position of the body 202, may be radially disposed at any position relative to the body 202 and relative to the flexible member 210, or the like.

The fluid 220 moving within the body 202 may have a temperature that is greater than a temperature of the body 202. The increased temperature of the fluid 220 increases the temperature of the body 202 and causes the body 202 to elongate. The rigid member 212 remains substantially stationary responsive to the fluid 220 moving through the body 202 and the flexible member 210. The rigid member 212 supports a load or an increasing load of the thermal expansion/pressure compensator 200 as well as internal pressures that may be present in the flow of fluid through the body 202. The flexible member 210 accommodates or supports expansion of the longitudinal section 240 responsive to the changing temperature of the fluid 220, and the rigid member 212 accommodates or supports the changing loads responsive to the changing temperature of the fluid 220 as well as any pressure (e.g., static and/or dynamic) within the compensator 200. For example, the flexible member 210 is shaped and sized to flex responsive to the increased temperature of the fluid 220 moving within the body 202, and the rigid member 212 is shaped and sized to remain substantially stationary responsive to the internal pressure and thermal expansion from the temperature of the fluid 220 moving within the body 202.

The rigid member 212 is thermally isolated from the body 202 and the flexible member 210. For example, the rigid member 212 is isolated from direct contact with the varying temperature fluid 220 inside the compensator 200. The temperature differential of the fluid 220 moving within the internal chamber 222 of the body 202 and within the flexible member 210 (e.g., the fluid 220 in direct contact with the body 202 and the flexible member 210) changes a temperature of the body 202 and the flexible member 210, and does not change a temperature of the rigid member 212 (or changes the temperature of the rigid member 212 by a smaller amount than the flexible member 210 and/or the body 202). The flexible member 210 is not thermally isolated from the body 202 because the fluid 220 having the temperature differential moves through the flexible member 210 within the body 202. The position of the rigid member 212 relative to the body 202 changes the thermal isolation of the rigid member 212. A rigid member disposed proximate to the body 202 may be exposed to an increased amount of thermal radiation from the body 202 relative to a rigid member disposed further away from the body 202. Additionally or alternatively, a portion of the rigid member 212 that is disposed proximate the body 202 may be exposed to an increased amount of thermal radiation from the body 202 relative to the portions of the rigid member 212 disposed further away from the body 202.

Additionally, the rigid member 212 is fluidly isolated from the body 202 and the flexible member 210. For example, the fluid 220 does not move or flow through the rigid member 212 and the rigid member 212 does not have direct contact with the fluid 220. Alternatively, the flexible member 210 is not fluidly isolated from the body 202 because the fluid 220 moves through the flexible member 210, and the flexible member 210 is fluidly coupled with the inlet 214 that directs the fluid 220 into the thermal expansion/pressure compensator 200 and is fluidly coupled with the outlet 216 that directs the fluid 220 out of the compensator 200.

The body 202, the flexible member 210, and the rigid member 212 are formed as a single, unitary structure with the internal chamber 222 extending within the body 202. For example, the thermal expansion/pressure compensator 200 including the body 202, the flexible member 210 having the protrusions 226, and the rigid member 212 may be additively manufactured. Additively manufacturing the thermal expansion/pressure compensator 200 allows for the compensator 200 to be more easily manufactured, more easily assembled, and reduces a number of potential failure modes or failure locations relative to non-additively manufactured assemblies (e.g., as shown in FIG. 1). Additive manufacturing can involve joining or solidifying material under computer control to create a three-dimensional object, such as by adding liquid molecules to, or fusing metal powder grains with each other. Examples of additive manufacturing include metal binder jetting, selective laser melting (SLM), electron beam melting (EBM), direct metal laser melting (DMLM), or the like. Alternatively, the thermal expansion/pressure compensator 200 can be formed in another manner, such as by casting, machining, or the like.

In one or more embodiments, the body 202, the flexible member 210, and the rigid member 212 may be additively manufactured as a unitary structure manufactured of a common metal or metal alloy. Optionally, one or more portions of the body 202, one or more portions of the flexible member 210, or one or more portions of the rigid member 212 may be manufactured of the same metal alloy having alternative material properties, manufactured of a different metal alloy, or the like. For example, the flexible member 210 may be manufactured of a metal alloy having elasticity properties that differ from a metal alloy used to manufacture the rigid member 212.

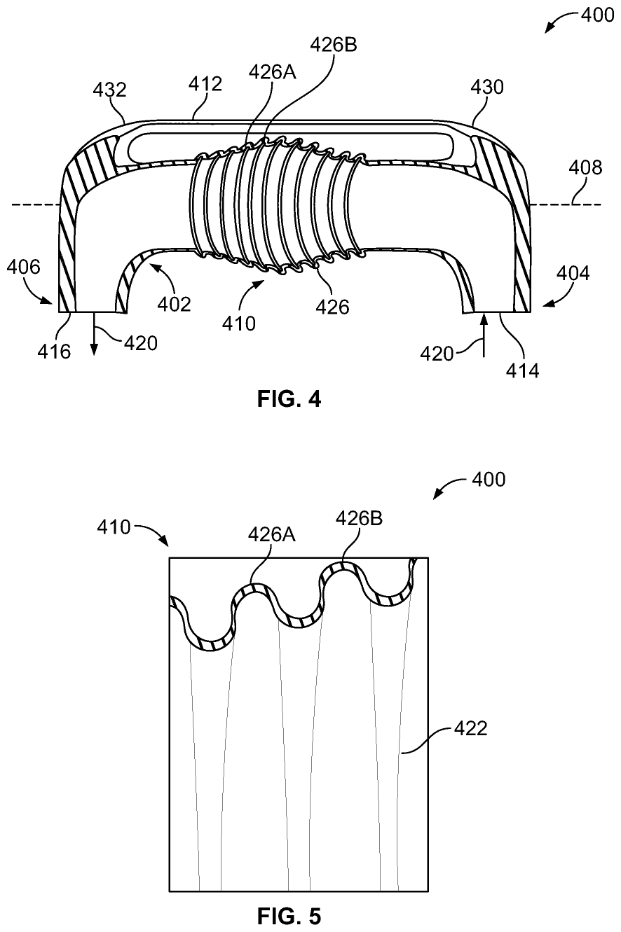

FIG. 4 illustrates a perspective view of a thermal expansion/pressure compensator 400 in accordance with one embodiment. FIG. 5 illustrates a magnified cross-sectional partial view of the thermal expansion/pressure compensator 400. The thermal expansion/pressure compensator 400 includes a body 402 having an inlet 414 at a first connection point 404 and an outlet 416 at a second connection point 406. Fluid 420 flows into the body 402 via the inlet 414, is received by an internal chamber 422, and flows out of the body 402 via the outlet 416. The body 402 may include one or more internal chambers 422, and each internal chamber may be fluidly coupled with each other internal chamber, fluidly coupled with the inlet 414, and/or fluidly coupled with the outlet 416.

The compensator 400 includes a flexible member 410 having plural protrusions 426 extending away from an exterior surface of the body 402. The flexible member 410 is like the flexible member 210 illustrated in FIGS. 2 and 3, however the protrusions 426 have varying sizes relative to each other. For example, a first protrusion 426A has a cross-sectional area that is smaller than a cross-sectional area of a second protrusion 426B. For example, the distance the protrusions 426 extend away from the exterior surface of the body 402 increases then decreases along a center axis 408 of the body 402 between the inlet 414 and the outlet 416. In alternative embodiments, the distance the protrusions 426 extend away from the exterior surface of the body 402 may decrease then increase along the center axis 408.

The thermal expansion/pressure compensator 400 also includes a rigid member 412 that extends between a first end 430 and a second end 432. The rigid member 412 is like the rigid member 212 illustrated in FIGS. 2 and 3, however the rigid member 412 is disposed at a different radial position away from the body 402. For example, the rigid member 212 extends along an inside portion of the body 402 between the inlet and outlet portions 236, 238, and the rigid member 412 extends along an outside portion of the body 402. The first end 430 and second end 432 of the rigid member 412 are coupled with body 402 at a top exterior surface or top portion of the body 402. In one or more embodiments, the thermal expansion/pressure compensator 400 may include a first rigid member 412 extending along an outside portion of the body 402 (e.g., outside of the U-shape bend of the body 402) and a second rigid member (not shown) extending along a different outside portion of the body 402 (e.g., extending inside the u-shape of the body 402 between the connection points). The second rigid member may be thermally and fluidly isolated from the body 402 and the flexible member 410, along with being thermally and fluidly isolated from the first rigid member.

The body 402, the flexible member 410, and the rigid member 412 are formed as a unitary structure. The flexible member 410 flexes, moves, bends, or the like, and the rigid member 412 remains substantially stationary responsive to the fluid 420 moving within the body 402. For example, the flexible member 410 accommodates the expansion of the body 402 due to the temperature differential of the fluid 420 moving within the compensator 400, and the rigid member 412 accommodates the varying load due to the changing pressure within the fluid moving through the compensator 400.

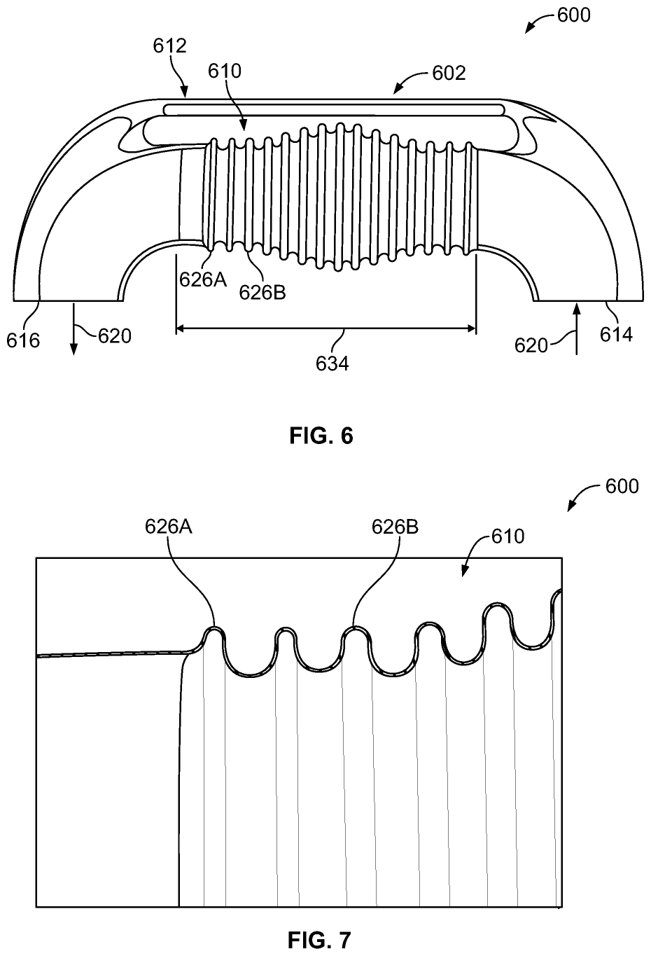

FIG. 6 illustrates a perspective view of a thermal expansion/pressure compensator 600 in accordance with one embodiment. FIG. 7 illustrates a magnified cross-sectional partial view of the thermal expansion/pressure compensator 600. The thermal expansion/pressure compensator 600 includes a body 602 having an inlet 614 and an outlet 616. Fluid 620 flows into the body 602 via the inlet 614, is received by an internal chamber, and flows out of the body 602 via the outlet 616. The compensator 600 includes a rigid member 612 and a flexible member 610 having plural protrusions 626 extending away from an exterior surface of the body 602. The flexible member 610 is like the flexible member 410 illustrated in FIGS. 4 and 5, however the flexible member 610 extends a length 634 along a portion of the body 602 that is longer than a length the flexible member 410 extends along the body 402. In alternative embodiments, the flexible member 610 may extend a length that is shorter than the length 634, the compensator 600 may include two separate flexible members 610 that extends along the length 634 or a different length, or the like.

The plural protrusions 626 of the flexible member 610 have varying wall thicknesses. For example, a first protrusion 626A has a wall thickness that is greater or thicker than a wall thickness of a second protrusion 626B. The protrusions 626 disposed proximate a center of the flexible member 610 along the length 634 may have wall thicknesses that are thinner than the wall thicknesses of the protrusions 626 disposed away from a center of the flexible member 610 along the length 634. For example, as the fluid moves from the inlet 614 to the outlet 616, the fluid may move through protrusions 626 having generally decreasing wall thicknesses followed by increasing wall thicknesses. Optionally, the protrusions 626 may have generally decreasing wall thicknesses followed by substantially common or the same wall thicknesses, or any combination therein.

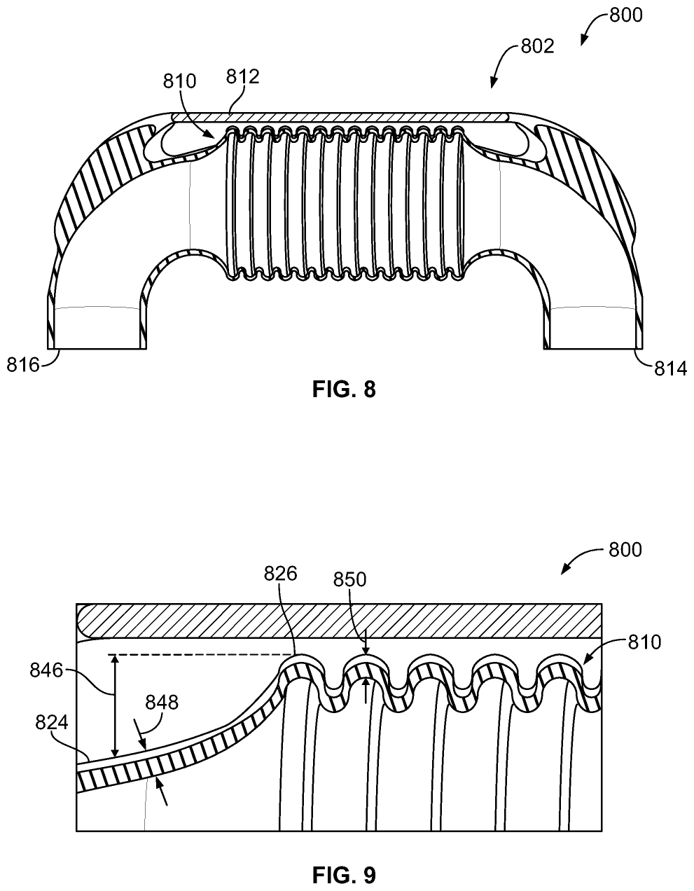

FIG. 8 illustrates a perspective view of a thermal expansion/pressure compensator 800 in accordance with one embodiment. FIG. 9 illustrates a magnified cross-sectional partial view of the thermal expansion/pressure compensator 800. The compensator 800 includes a body 802 having an inlet 814 and an outlet 816. The compensator 800 also includes a rigid member 812 and a flexible member 810 having plural protrusions 826. The flexible member 810 is like the flexible member 610 illustrated in FIGS. 6 and 7, however the protrusions 826 of the flexible member 810 extend a distance 846 away from an exterior surface 824 of the body 802 that is greater than a distance away the protrusions 626 extend away from an exterior surface of the body 602. For example, the cross-sectional size of the bellow or flexible member 810 is greater than a cross-sectional size of the flexible member 610.

In the illustrated embodiment of FIGS. 8 and 9, the flexible member 810, and the protrusions 826 of the flexible member 810, has a wall thickness 850 that is thinner than a wall thickness 848 of the body 802. In the illustrated embodiment, each protrusion 826 has a wall thickness that is substantially the same as a wall thickness of each other protrusion, however one or more protrusions may have a thinner or thicker wall thickness. Optionally, the body 802, the flexible member 810, and/or each protrusion 826 may have any other size relative to each other.

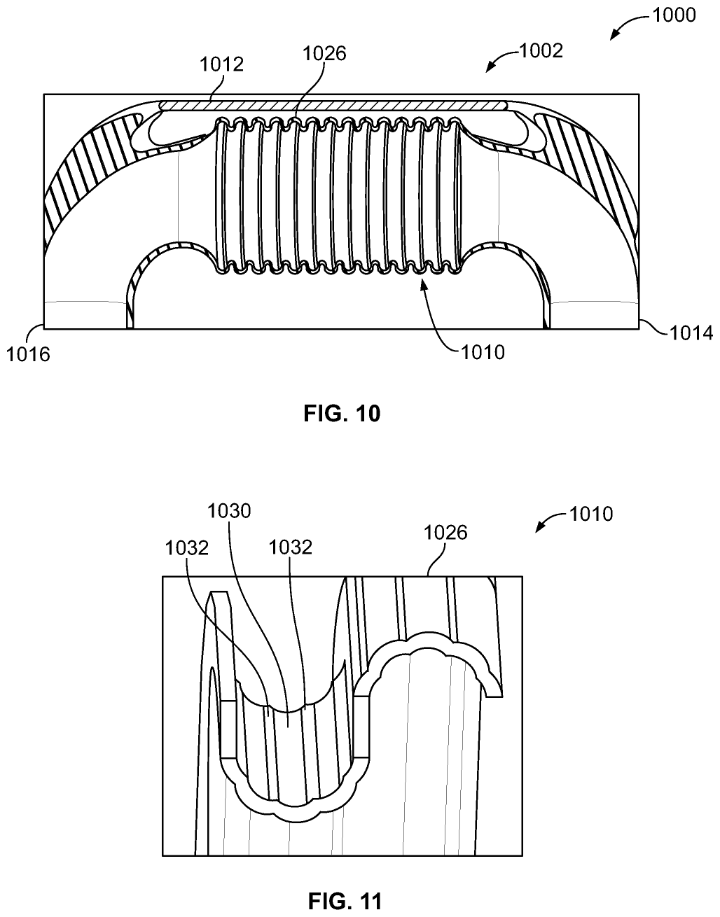

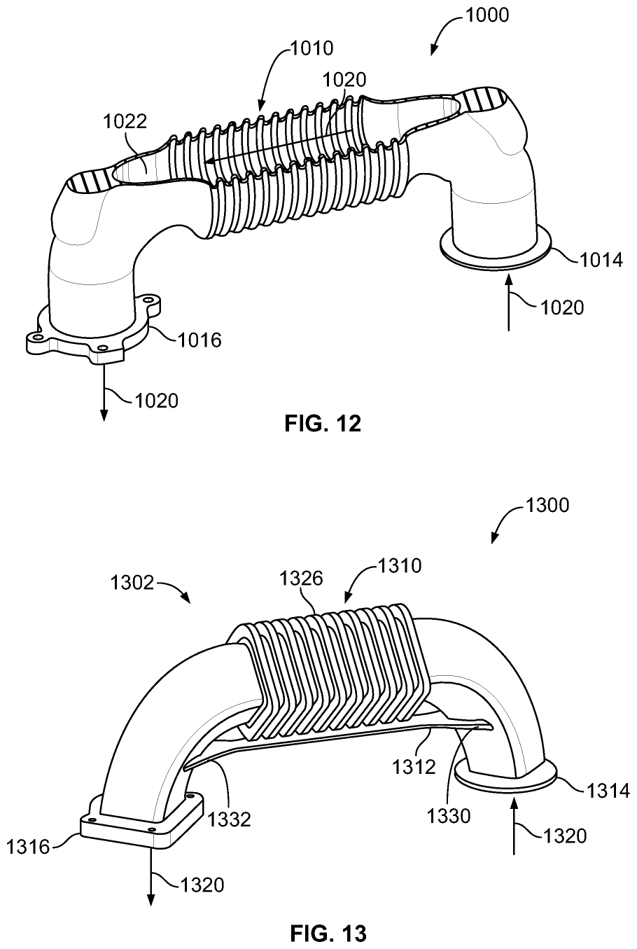

FIG. 10 illustrates a perspective view of a thermal expansion/pressure compensator 1000 in accordance with one embodiment. FIG. 11 illustrates a magnified cross-sectional partial view of the thermal expansion/pressure compensator 1000. FIG. 12 illustrates a cross-sectional view of a flexible member 1010 of the thermal expansion/pressure compensator 1000. The compensator 1000 includes a body 1002 having an inlet 1014, an outlet 1016, and an internal chamber 1022 defined by hermetic walls of the body 1002. The compensator 1000 also includes a rigid member 1012, and the flexible member 1010 having plural protrusions 1026. Fluid 1020 flows into the body 1002 via the inlet 1014, moves through the internal chamber 1022 and through the flexible member 1010, and out of the body 1002 via the outlet 1016.

The flexible member 1010 is like the flexible member 810 illustrated in FIGS. 8 and 9, however the protrusions 1026 of the flexible member 1010 include plural convolutes 1030, 1032 within and along each protrusion 1026. For example, the plural convolutes 1030, 1032 are accordion-like or wave-like structures that extend along each of the protrusions 1026. The convolutes 1030, 1032 extend into and subsequently extend away a center of each protrusion such that an exterior surface of the flexible member 1010 is a wave-like exterior surface. In alternative embodiments, the convolutes may have any alternative shape and/or size, may have any repeating pattern or random configuration, or any combination therein. Optionally, the protrusions 1026 may include varying wall thicknesses at different positions along an exterior surface of one or more protrusions.

FIG. 13 illustrates a perspective view of a thermal expansion/pressure compensator 1300. The thermal expansion/pressure compensator 1300 has a body 1302 having an inlet 1314 and an outlet 1316. The compensator 1300 also includes a rigid member 1312 and a flexible member 1310 having plural protrusions 1326 that radially extend about a center axis of the body 1302 away from an exterior surface of the body 1302. The flexible member 1310 is like the flexible member 1010 illustrated in FIGS. 10 through 12, however the protrusions 1326 of the flexible member 1310 have a substantially rectangular cross-sectional shape. Additionally, the body 1302 is like the body 1002 illustrated in FIGS. 10 through 12, however the body 1302 has a substantially rectangular shape instead of a substantially circular shape of the body 1002. In alternative embodiments, the body 1302 and/or one or more of the protrusions 1326 may have any alternative shape and/or size relative to each other, and relative to each other protrusion.

The rigid member 1312 extends between a first end 1330 and a second end 1332 in a direction along a center axis of the body 1302. The rigid member 1312 is disposed at a radial position away from the body 1302. In the illustrated embodiment, the rigid member 1312 extends along an inside portion of the body 1302 (e.g., inside of the U-shape bend of the body 1302). In one or more embodiments, the compensator 1300 may also include a second rigid member (not shown) that may extend along an outside portion of the body 1302 (e.g., outside of the U-shape bend of the body 1302) like the rigid member 1012 illustrated in FIG. 10. Optionally, the thermal expansion/pressure compensator 1300 may also include one or more rigid members extending along the center axis at any alternative radial position away from the body 1302, such as along a side of the body 1302, or the like. The flexible member 1310 flexes or moves responsive to the fluid 1320 moving through the body 1302, and the rigid member 1312 remains substantially stationary responsive to the fluid 1320 moving through the body 1302.

In one or more embodiments of the subject matter described herein, a thermal expansion/pressure compensator includes a body having an inlet at a first connection point and an outlet at a second connection point. The body includes a flexible member extending along a portion of the body. The body has an internal chamber configured to receive a fluid via the inlet. The internal chamber is shaped to direct fluid through the flexible member and out of the body via the outlet. The flexible member is configured to flex responsive to expansion of the body. The compensator also includes a rigid member operably coupled with the body. The rigid member is thermally and fluidly isolated from the body and the flexible member. The body, the flexible member, and the rigid member are formed as a unitary structure.

Optionally, the flexible member has a wall thickness that is thinner than a wall thickness of the body.

Optionally, the flexible member is a first flexible member. The body also includes a second flexible member that extends along a different, second portion of the body than the first flexible member.

Optionally, the body includes one or more hermetic walls extending around and enclosing the internal chamber.

Optionally, the body includes a body cross-sectional area and the flexible member includes a member cross-sectional area. The member cross-sectional area is larger than the body cross-sectional area.

Optionally, the flexible member includes one or more protrusions extending away from an exterior surface of the body.

Optionally, each of the one or more protrusions radially extends about a center axis of the body.

Optionally, the protrusions have differently sized cross-sectional areas.

Optionally, the rigid member includes a rigid body extending between a first end and a second end. The first end of the rigid body is coupled with the body at a first location of the body and the second end of the rigid body is coupled with the body at a second location of the body.

Optionally, the rigid member is a first rigid member. The compensator also includes a second rigid member. The first rigid member is coupled with the body at a first position of the body and the second rigid member is coupled with the body at a second position of the body.

Optionally, the first rigid member is thermally and fluidly isolated from the body, the flexible member, and the second rigid member.

Optionally, the flexible member is configured to flex responsive to the fluid moving through the body, and the rigid member is configured to remain stationary responsive to the fluid moving through the body.

Optionally, the body, the flexible member, and the rigid member are additively manufactured as the unitary structure.

Optionally, the rigid member is configured to extend along a center axis of the body at a radial position away from the body.

Optionally, the flexible member is configured to flex in two or more directions responsive to the expansion of the body.

In one or more embodiments of the subject matter described herein, a thermal expansion/pressure compensator includes a body having an inlet at a first connection point and an outlet at a second connection point. The body includes one or more hermetic walls extending around and enclosing an internal chamber. The internal chamber receives a fluid via the inlet. The internal chamber is shaped to direct fluid through the body and the out of the body via the outlet. The compensator also includes a flexible member coupled with the body and extending along a portion of the body. The flexible member has a wall thickness that is thinner than a wall thickness of the body. The flexible member is configured to flex responsive to expansion of the body as a result of fluid moving within the internal chamber of the body. The compensator also includes a rigid member operably coupled with the body. The rigid member is thermally and fluidly isolated from the body and the flexible member. The rigid member is configured to remain stationary responsive to the fluid moving through the body. The body, the flexible member, and the rigid member are formed as a unitary structure.

Optionally, the flexible member is a first flexible member. The body also includes a second flexible member that extends along a different, second portion of the body than the first flexible member.

Optionally, the body includes a body cross-sectional area and the flexible member includes a member cross-sectional area. The member cross-sectional area is larger than the body cross-sectional area.

Optionally, the flexible member includes one or more protrusions extending away from an exterior surface of the body.

Optionally, each of the one or more protrusions radially extends about a center axis of the body.

Optionally, the protrusions have differently sized cross-sectional areas.

Optionally, the rigid member includes a rigid body extending between a first end and a second end. The first end of the rigid body is coupled with the body at a first location of the body and the second end of the rigid body is coupled with the body at a second location of the body.

Optionally, the rigid member is a first rigid member. The thermal expansion/pressure compensator also includes a second rigid member. The first rigid member is coupled with the body at a first position of the body, and the second rigid member is coupled with the body at a second position of the body.

Optionally, the flexible member is configured to flex responsive to the expansion of the body, and the rigid member is configured to remain stationary responsive to the expansion of the body.

Optionally, the body, the flexible member, and the rigid member are additively manufactured as the unitary structure.

Optionally, the rigid member includes a rigid body extending along a center axis of the body at a radial position away from the body.

Optionally, the flexible member is configured to flex in two or more directions responsive to the expansion of the body.

In one or more embodiments of the subject matter described herein, a thermal expansion/pressure compensator includes a body having an inlet at a first connection point and an outlet at a second connection point. The body includes one or more hermetic walls extending around and enclosing an internal chamber. The internal chamber is configured to receive a fluid via the inlet and is shaped to direct the fluid through the body and out of the body via the outlet. A flexible member is coupled with the body and extends along a portion of the body. The flexible member includes one or more protrusions extending away from an exterior surface of the body. Each of the one or more protrusions radially extends around a center axis of the body. Each protrusion has a wall thickness that is thinner than a wall thickness of the body. The flexible member is configured to flex responsive to expansion of the body. A rigid member is operably coupled with the body and includes a rigid body extending along a center axis of the body at a radial position away from the body. The rigid member is thermally and fluidly isolated from the body and the flexible member. The rigid member is configured to remain stationary responsive to the fluid moving through the body. The body, the flexible member, and the rigid member are additively manufactured as a unitary structure.

It is to be understood that the above description is intended to be illustrative, and not restrictive. For example, the above-described embodiments (and/or examples thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A thermal expansion/pressure compensator comprising:
a body comprising an inlet at a first connection point and an outlet at a second connection point, the body comprising a flexible member extending along a portion of the body, wherein the body has an internal chamber configured to receive a fluid via the inlet, the internal chamber shaped to direct fluid through the flexible member and out of the body via the outlet, wherein the flexible member is configured to flex responsive to expansion of the body; and
a rigid member operably coupled with the body, wherein the rigid member is thermally and fluidly isolated from the body and the flexible member,
wherein the body, the flexible member and the rigid member are formed as a unitary structure.

2. The thermal expansion/pressure compensator of claim 1, wherein the flexible member has a wall thickness that is thinner than a wall thickness of the body.

3. The thermal expansion/pressure compensator of claim 1, wherein the flexible member is a first flexible member, the body further comprising a second flexible member that extends along a different, second portion of the body than the first flexible member.

4. The thermal expansion/pressure compensator of claim 1, wherein the body includes one or more hermetic walls extending around and enclosing the internal chamber.

5. The thermal expansion/pressure compensator of claim 1, wherein the body includes a body cross-sectional area and the flexible member includes a member cross-sectional area, wherein the member cross-sectional area is larger than the body cross-sectional area.

6. The thermal expansion/pressure compensator of claim 1, wherein the flexible member includes one or more protrusions extending away from an exterior surface of the body.

7. The thermal expansion/pressure compensator of claim 6, wherein each of the one or more protrusions radially extends about a center axis of the body.

8. The thermal expansion/pressure compensator of claim 6, wherein the protrusions have differently sized cross-sectional areas.

9. The thermal expansion/pressure compensator of claim 1, wherein the rigid member includes a rigid body extending between a first end and a second end, wherein the first end of the rigid body is coupled with the body at a first location of the body and the second end of the rigid body is coupled with the body at a second location of the body.

10. The thermal expansion/pressure compensator of claim 1, wherein the rigid member is a first rigid member, the thermal expansion/pressure compensator further comprising a second rigid member, wherein the first rigid member is coupled with the body at a first position of the body and the second rigid member is coupled with the body at a second position of the body.

11. The thermal expansion/pressure compensator of claim 10, wherein the first rigid member is thermally and fluidly isolated from the body, the flexible member, and the second rigid member.

12. The thermal expansion/pressure compensator of claim 1, wherein the flexible member is configured to flex responsive to the fluid moving through the body, and wherein the rigid member is configured to remain stationary responsive to the fluid moving through the body.

13. The thermal expansion/pressure compensator of claim 1, wherein the body, the flexible member and the rigid member are additively manufactured as the unitary structure.

14. The thermal expansion/pressure compensator of claim 1, wherein the rigid member is configured to extend along a center axis of the body at a radial position away from the body.

15. The thermal expansion/pressure compensator of claim 1, wherein the flexible member is configured to flex in two or more directions responsive to the expansion of the body.

16. A thermal expansion/pressure compensator comprising:
a body comprising an inlet at a first connection point and an outlet at a second connection point, wherein the body includes one or more hermetic walls extending around and enclosing an internal chamber, the internal chamber configured to receive a fluid via the inlet, the internal chamber shaped to direct fluid through the body and out of the body via the outlet,
a flexible member coupled with the body and extending along a portion of the body, wherein the flexible member has a wall thickness that is thinner than a wall thickness of the body, wherein the flexible member is configured to flex responsive to expansion of the body as a result of the fluid moving within the internal chamber of the body; and
a rigid member operably coupled with the body, wherein the rigid member is thermally and fluidly isolated from the body and the flexible member, wherein the rigid member is configured to remain stationary responsive to the fluid moving through the body,
wherein the body, the flexible member and the rigid member are formed as a unitary structure.

17. The thermal expansion/pressure compensator of claim 16, wherein the flexible member is a first flexible member, the body further comprising a second flexible member that extends along a different, second portion of the body than the first flexible member.

18. The thermal expansion/pressure compensator of claim 16, wherein the body includes a body cross-sectional area and the flexible member includes a member cross-sectional area, wherein the member cross-sectional area is larger than the body cross-sectional area.

19. The thermal expansion/pressure compensator of claim 16, wherein the flexible member includes one or more protrusions extending away from an exterior surface of the body.

20. The thermal expansion/pressure compensator of claim 19, wherein each of the one or more protrusions radially extends about a center axis of the body.

21. The thermal expansion/pressure compensator of claim 19, wherein the protrusions have differently sized cross-sectional areas.

22. The thermal expansion/pressure compensator of claim 16, wherein the rigid member includes a rigid body extending between a first end and a second end, wherein the first end of the rigid body is coupled with the body at a first location of the body and the second end of the rigid body is coupled with the body at a second location of the body.

23. The thermal expansion/pressure compensator of claim 16, wherein the rigid member is a first rigid member, the thermal expansion/pressure compensator further comprising a second rigid member, wherein the first rigid member is coupled with the body at a first position of the body and the second rigid member is coupled with the body at a second position of the body.

24. The thermal expansion/pressure compensator of claim 16, wherein the flexible member is configured to flex responsive to the expansion of the body, and wherein the rigid member is configured to remain stationary responsive to the expansion of the body.

25. The thermal expansion/pressure compensator of claim 16, wherein the body, the flexible member, and the rigid member are additively manufactured as the unitary structure.

26. The thermal expansion/pressure compensator of claim 16, wherein the rigid member includes a rigid body extending along a center axis of the body at a radial position away from the body.

27. The thermal expansion/pressure compensator of claim 16, wherein the flexible member is configured to flex in two or more directions responsive to the expansion of the body.

28. A thermal expansion/pressure compensator comprising:
a body comprising an inlet at a first connection point and an outlet at a second connection point, wherein the body includes one or more hermetic walls extending around and enclosing an internal chamber, the internal chamber configured to receive a fluid via the inlet, the internal chamber shaped to direct fluid through the body and out of the body via the outlet,
a flexible member coupled with the body and extending along a portion of the body, the flexible member including one or more protrusions extending away from an exterior surface of the body, wherein each of the one or more protrusions radially extends about a center axis of the body, each of the one or more protrusions having a wall thickness that is thinner than a wall thickness of the body, wherein the flexible member is configured to flex responsive to expansion of the body as a result of the fluid moving within the internal chamber of the body; and
a rigid member operably coupled with the body, the rigid member including a rigid body extending along a center axis of the body at a radial position away from the body, wherein the rigid member is thermally and fluidly isolated from the body and the flexible member, wherein the rigid member is configured to remain stationary responsive to the fluid moving through the body,
wherein the body, the flexible member and the rigid member are additively manufactured as a unitary structure.
